(19) United States
(12) Patent Application Publication
(10) Pub. No.: US 2015/0170202 A1
(43) Pub. Date: Jun. 18, 2015

(54) Computer-Based Apparatus And Method For Multi-Channel Shopping With Dual Interactivity

(71) Applicant: Gene Frisco, New York, NY (US)

(72) Inventor: Gene Frisco, New York, NY (US)

(21) Appl. No.: 14/133,582

(22) Filed: Dec. 18, 2013

(51) Int. Cl. G06Q 30/02

(52) U.S. Cl. CPC G06Q 30/0253; G06Q 30/0281

(57) ABSTRACT

A computer-based apparatus and method for multi-channel shopping with dual interactivity between a referring publisher and a selling merchant. A dual interactive Engine comprising a set of functional processes that enable a referring publisher to view merchants and enable merchants to view referring publishers and the engine implements an automatic process that automatically determines referring publisher's identity and establishes a relationship between a referring publisher and a merchant.

### CROSS-REFERENCE

This application claims the priority of the U.S. Provisional Patent Application No. 61/738,630 filed on Dec. 18, 2012, entirety of which is hereby incorporated by reference.

### BACKGROUND OF THE INVENTION

1. Field of the Invention

The present disclosure relates to a computer-based apparatus and method for multi-channel shopping with dual interactivity, in particular, the apparatus and method enables simultaneous multi-channel shopping and dually interactivity with both a referring publisher and a selling merchant.

2. Description of Related Art

Known ecommerce systems generally include multi-channel selling. One model is to affiliate marketing to a single shopping environment. Another model involves a multitude of channel marketers who provide distinct and separate shopping experiences for a single offer via an intermediate entity between the consumer and the selling merchant.

In the affiliate model, a merchant seller of a good or service via ecommerce offers a reward or commission to referring publishers as “affiliates” for each consumer directed to the merchant's online shopping environment or for the completion of a purchase. In this model, the only interaction the referring publisher channel has with the consumer is in broadcasting the offer, for example, through an online advertisement or an email communication. The consumer's experience in the shopping environment is “behind the wall” of the merchant's servers. The tracking mechanism for the referring publisher channel marketer may include firing pixel that activates on the final page of the checkout process. There is no interactivity between the referrer and the purchaser beyond the activating message. The referring publisher is informed of a completed sale usually by an intermediary. There is little or no information about the identity of the purchaser and therefore, the referring publisher can only derive generic metrics about the success of the publisher's advertising and gains, no information about the identity and behavior of specific consumers.

The other multi-channel marketing model, developed in the travel and hospitality industries, however, only allows the marketing publisher to have the total control of the consumer information, while the service providers remain “behind the wall”. The established GDS architecture allows intermediary travel sites to access hotel and airline inventory and sell this inventory through websites for the travel sites. The interactivity in this model is between the channel marketer and the common platform system, which reports on the availability of inventory at a multitude of merchants, and between the channel marketer and the consumer. But all the consumer interaction is on the channel marketer's side of the wall. The consumer is “passed” to the service or product merchant as a completed transaction with a purchase receipt generated by the referring merchant.

The “daily deal” industry has developed two distinct modes of selling merchants' goods and services via vouchers, but both modes are interactive only between the consumer and the ultimate seller of the voucher. In one mode of the daily deal industry, an offer is made through an on-line site. In order to sell through this model, the merchant is intermediated by group buying site brands which interact with the consumer in respective distinct purchase environments particular to a group buying site. Again, the consumer is “passed” to the service or product merchant as a completed transaction. In another mode of the daily deal industry, on-line deal aggregators aggregate merchant's offers on other selling websites but the result for the merchant is the same as in the first mode. That is, the merchant is required to track as many web generated types of vouchers as there were sites on which the vouchers were sold, and the selling merchant has limited or no access to the identity and activity of the shopping and purchasing consumers. If a merchant wants to take advantage of a wide array of selling channels, the merchant must find a way to track as many vouchers as there are outlets for their deals and the lack of information about purchasers and limitations on purchasers by the merchant becomes even more complicated.

Accordingly, there is a need for an improved multichannel marketing system where all sides of the participating parties can access information and have dual interactivity.

### SUMMARY

According to aspects illustrated herein, there is provided a computer-based apparatus and method for multi-channel shopping with dual interactivity, in particular, the apparatus and method enables simultaneous multi-channel shopping and dually interactivity with both a referring publisher and a selling merchant.

In one embodiment, a central access engine (herein Silk Engine) and network system is provided that enables the automatic identification of a referring publisher, a merchant, a consumer, and the association of the referred customer and its market activity to its referring publisher and the sales merchant.

In one embodiment, a referring publisher is enabled to access and track information about its referred consumers, reports of the related merchants and published deals.

In one embodiment, a referred consumer is enabled to access and track information about its orders, available deals and the related merchants.

In one embodiment, a merchant is enabled to access and track information about its vouchers, incentive gifts and promotions to different referring publishers, and the related consumer orders and activities.

The above and other aspects, features and advantages of the present invention will become apparent from the following description read in conjunction with the accompanying drawings, in which like reference numerals designate the same elements.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a pictorial example overview of a computer-based apparatus and method for multi-channel shopping with dual interactivity;

FIG. 2 is a pictorial representation of example functioning of a computer-based apparatus and method for multi-channel shopping with dual interactivity;

FIG. 3 is a flow chart illustrating a process for determining a referring publisher in a computer-based apparatus and method for multi-channel shopping with dual interactivity;

FIG. 4 is a flow chart for checking status of an order in a computer-based apparatus and method for multi-channel shopping with dual interactivity;

FIG. 5 is a flow chart for a process requesting status of an order via email in a computer-based apparatus and method for multi-channel shopping with dual interactivity;

FIG. 6 is a flow chart for a process viewing merchants in a computer-based apparatus and method for multi-channel shopping with dual interactivity;

FIG. 7 is a flow chart for viewing merchant deals in a computer-based apparatus and method for multi-channel shopping with dual interactivity;

FIG. 8 is a flow chart for viewing merchant orders in a computer-based apparatus and method for multi-channel shopping with dual interactivity;

FIG. 9 is a flow chart for a process for clicking on deal from referring publisher in a computer-based apparatus and method for multi-channel shopping with dual interactivity;

FIG. 10 is a flow chart for a process for viewing merchant orders in a computer-based apparatus and method for multi-channel shopping with dual interactivity;

FIG. 11 is a chart showing example participants in a computer-based apparatus and method for multi-channel shopping with dual interactivity and examples of the nature of the participation;

FIGS. 12, 13, and 14 are pictorial representation of an example computer screen display for a computer-based apparatus and method for multi-channel shopping with dual interactivity showing a user logged onto a multi-channel shopping network with dual interactivity as an administrator, as a publisher, and as merchant, respectively;

FIG. 15 is a chart illustrating an example use of a computer-based apparatus and method for multi-channel shopping with dual interactivity;

FIG. 16 is a chart illustrating example relationships of publishers and selling merchants.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, Java, COBOL, assembler, PERL, or and other suitable software languages, with the various algorithms being implemented with any combination of data structures, objects, processes, routines, or other programming elements. Further, it should be noted that the present invention may employ any number of conventional techniques for data transmission, signaling, data processing, network control, and the like, known in the field of art.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

Communication between participants in the system of the present invention is accomplished through any suitable communication means, such as, for example, a telephone network, public switch telephone network, intranet, Internet, extranet, WAN, LAN, point of interaction device (e.g., point of sale device, personal digital assistant, cellular phone, kiosk terminal, automated teller machine (ATM), etc.), online communications, off-line communications, wireless communications, satellite communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

It further will be appreciated that users may interact with like the system via any input device such as a keyboard, mouse, kiosk, personal digital assistant, handheld computer (e.g., Palm Pilot®), cellular phone, and/or the like. Similarly, the invention could be used in conjunction with any type of personal computer, network computer, workstation, minicomputer, mainframe, or the like, running any operating system, such as any version of Windows, MacOS, OS/2, BeOS, Linux, UNIX, or the like. Moreover, although the invention may be described herein as being implemented with TCP/IP communications protocols, it will be readily understood that the invention could also be implemented using IPX, Appletalk, IP-6, NetBIOS, OSI, or any number of existing or future protocols. Moreover, the system contemplates the use, sale, or distribution of any goods, services, or information over any network having similar functionality described herein.

Each participant or user of the system of the present invention, including purchasers, retailers, manufacturers, and a third-party providers, may be equipped with a suitable computing system to facilitate online communications and transactions with any other participants. For example, some or all participants may have access to a computing unit in the form of a personal computer, although other types of computing units may be used, including laptops, notebooks, handheld computers, set-top boxes, kiosk terminals, and the like. Additionally other participants may have computing systems which may be implemented in the form of a computer-server, a PC server, a networked set of computers, or any other suitable implementations which are known in the art or may hereafter be devised.

As will be appreciated by one of ordinary skill in the art, the present invention may be embodied as a method, a data processing system, a device for data processing, and/or a computer program product. Accordingly, aspects of the present invention may take the form of an entirely software embodiment an entirely hardware embodiment, or combining aspects of both software and hardware embodiment. Furthermore, the present invention may take the font of a computer program product on a computer-readable storage medium having computer-readable program-code means embodied in the storage medium. Any suitable computer-readable storage medium may be utilized, including hard disks, CD-ROM, optical storage devices, magnetic storage devices, and/or the like.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose, hardware-based computer systems which perform the specified functions or steps, or suitable combinations of special purpose hardware and computer instructions.

As used herein, the terms “purchaser”, “customer”, “consumer”, and “end-user” may be used interchangeably with each other, and each shall mean any person, entity, charitable organization, or business which uses a consumer ID to participate in the present system. A “consumer ID”, as used herein, includes any device, code, or other identifier suitably configured to allow the consumer to interact or communicate with the system, such as, for example, a rewards card, charge card, credit card, debit card, prepaid card, telephone card, smart card, magnetic stripe card, bar code card, authorization access code, personal identification number (PIN), Internet code, other identification code, and/or the like. Additionally, a “consumer ID” may comprise any form of electronic, magnetic, and/or optical device capable of transmitting or downloading data from itself to a second device which is capable of interacting and communicating with such forms of consumer I.D.

The following specifications are applicable:

Cocoon—In a computer-based apparatus and method for multi-channel shopping with dual interactivity, each ecommerce installation is its own discrete cocoon and the apparatus and method pulls threads of data from a multitude of cocoons and aggregates it in the engine for parsing according to each selling merchant and each referring publisher.

Deal—A product or service for sale at a discount for a limited period of time.

Gift voucher—A voucher for a product of service with an expiration date.

Landing page—A specific web page tailored to a deal. The page is intended to expand on content from a click form a referring publisher.

Order—Purchased gift voucher.

Product—A physical or virtual item for sale in merchant's ecommerce system.

Referring Publisher—Any actor that activates a referral to a selling merchant either by a push email to that publishers email list or by a contact form on website or by any other means of communication to the publisher's community of consumers.

Service—One or more tasks to be performed at a merchant's location.

Wall—The “wall” in a traditional ecommerce design is the information boundary created in any secure server environment. Transaction data on one selling merchant server is secured by restricting access to the server. Thus, the archetypal way of reporting sales activity from a selling merchant to a referring publisher is the firing pixel that is released back to the publisher from the confirmation page on the completion of a sale transaction or offer form registration. In a computer-based apparatus and method for multi-channel shopping with dual interactivity, a wall resides outside the secure server environment with transaction data from a multitude of referring publishers and selling merchants because it establishes a “wall” between and among the transactions of all the constituents and makes transactions simultaneously visible only to an actor who is a party to one side of the transaction.

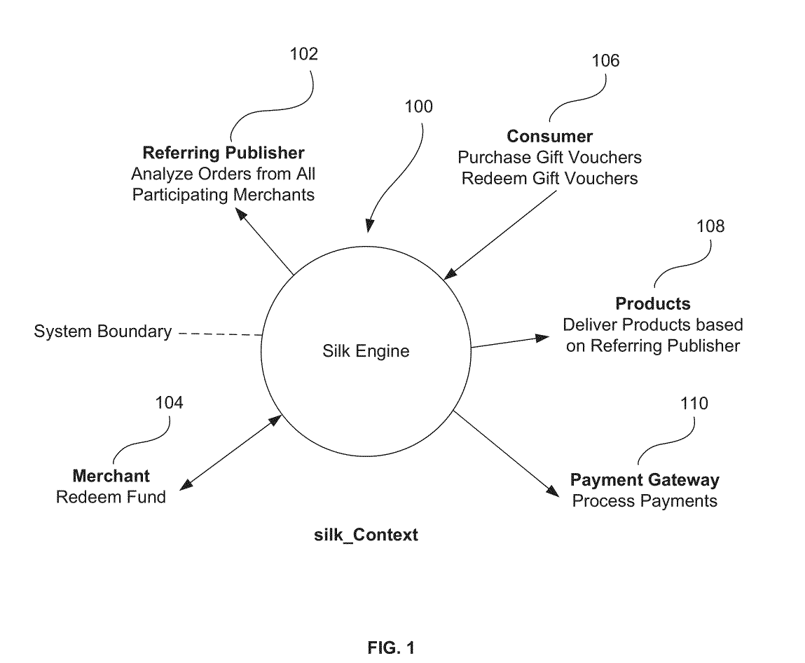

In reference to FIG. 1, apparatus, method, and system 100 (Silk Engine) is a novel ecommerce architecture and engine that is simultaneously a multi-channel shopping network and dually interactive with both referring publisher channels and the selling merchants. FIG. 1 shows a pictorial example overview of computer-based apparatus, method and system 100 for multi-channel shopping with dual interactivity that include the multitude of interactions between referring publisher 102, merchant 104, consumer (customer/purchaser) 106, products 108, and payment gateway 110 interacting through various processes.

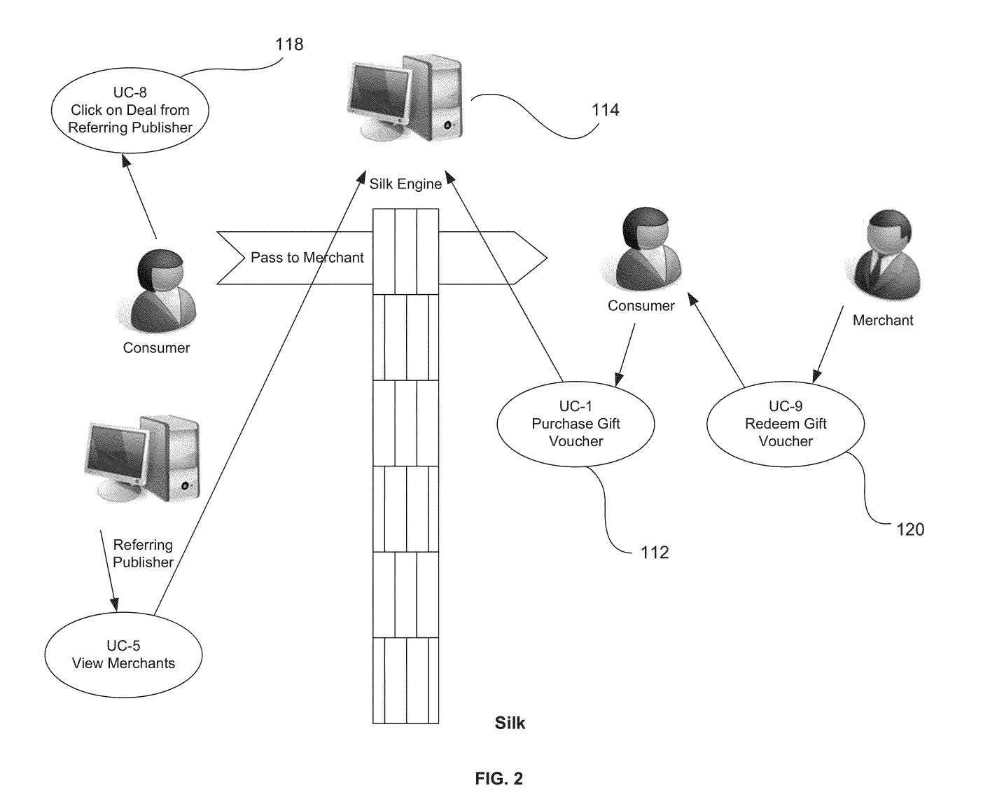

In reference to FIG. 2, it is a pictorial representation of example functioning processes of the interacting parties. In the system, the interactions are divided into two realms, connected by the SILK Wall created by the SILK Engine 100 in between. The sales and merchant related interactions are confined within the right side “Cocoon”, where a Referring Publisher is restricted to the outside of the Cocoon and cannot participate the processes inside the Cocoon, but can see and watch through the Silk Engine 100 about what is going on inside the Cocoon. The functioning processes that are restricted outside the Cocoon, on the left side of FIG. 2, include View Merchant process 116 by a referring publisher, Click on Deal from a Referring Publisher process 118 by a consumer. The functional processes that are restricted to within the Cocoon are limited to between Consumer and Merchant, including Purchase Voucher process 112 for a consumer, Redeem Gift Voucher process 120 accessible by either a consumer or a merchant. The Silk Engine 100 implements an automatic Determine Referring Publisher process 114 that allows and enables a Referring Publisher or a Merchant to see and watch the activities on each side. The Referring Publisher is enabled to see and watch what is going on within the Cocoon, and the Merchant is enabled to see and watch what is going on outside the Cocoon, the Referring Publisher's world.

Between a Merchant and Consumer, transactions can be accomplished by Process 112 as follows:
1. Add Gift Voucher to Shopping Cart cocoon;
2. Register on Silk Engine (apparatus and method 100);
3. Enter Shipping Information;
4. Enter Billing Information;
5. Complete Purchase;
6. Gift Voucher is sent to Gift Voucher recipient's email address;
7. Confirmation of purchase is sent to Consumer's email address; and
8. Gift Voucher may be printed.

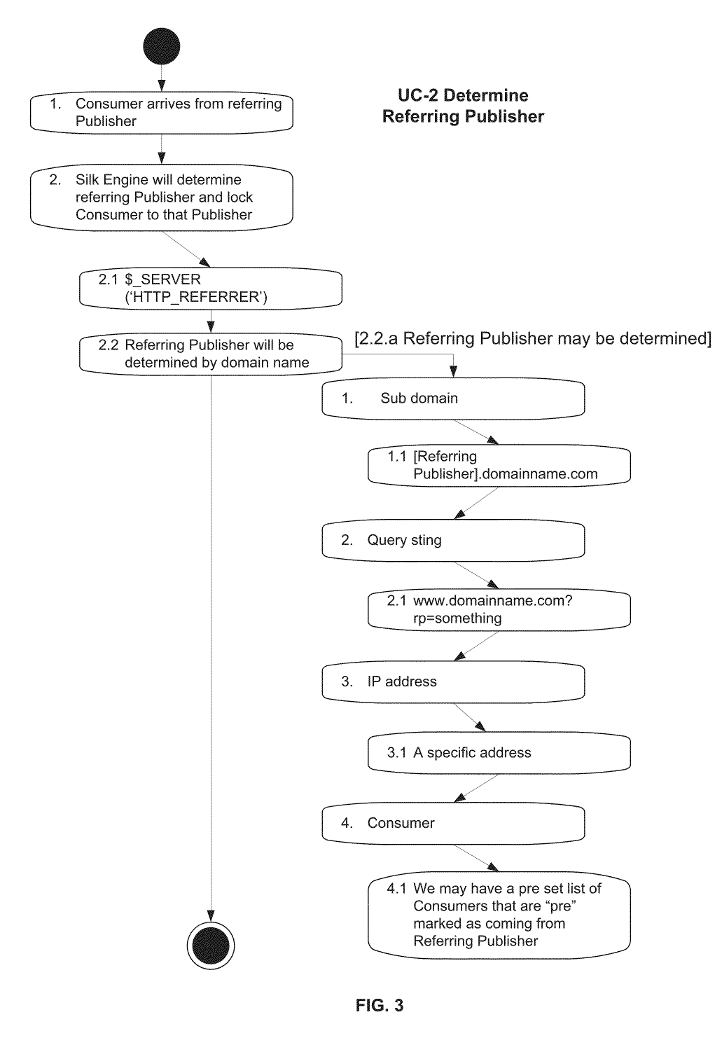

FIG. 3 is a flow chart illustrating process 114 in which a referring publisher is automatically determined as follows:
1. Consumer arrives from Referring Publisher; and
2. Apparatus and method 100 determines Referring Publisher and locks Consumer to that Publisher through 2.1. [‘HTTP REFERER’]; and
2.2. Referring Publisher will be determined by domain name. In an example embodiment, the referring publisher is determined as follows:
   2.2. a Referring Publisher may be determined by other
      1. Sub domain:
         1.1. [Referring Publisher].domainname com;
      2. Query sting:
         2.1. www.domainname.com?rp=something;
      3. IP address:
         3.1. A specific IP address; or
      4. Consumer:
         4.1. A pre-set list of Consumers that are “pre” marked as coming from Referring Publisher.

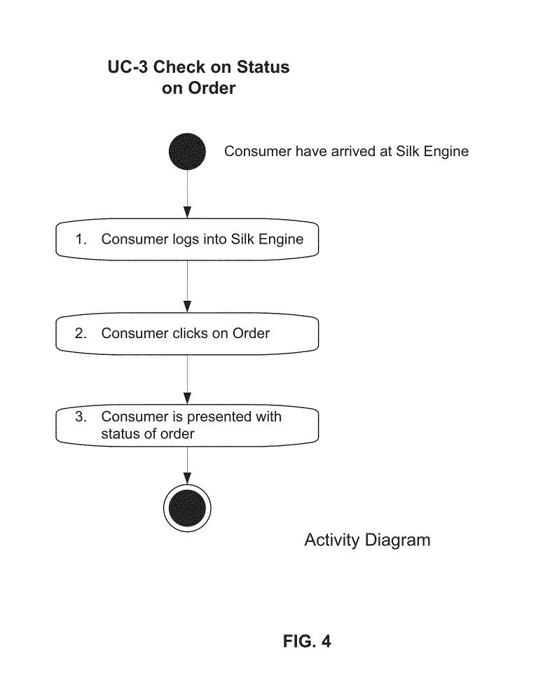

FIG. 4 illustrates a flow chart for checking status by a consumer. The consumer logs into apparatus, method and system 100, clicks on an order, and is presented with status of the order.

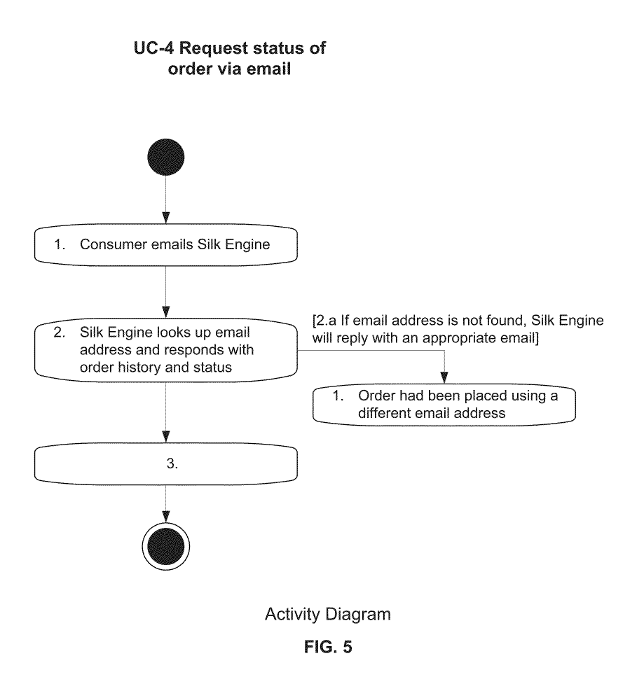

FIG. 5 illustrates a flow chart for requesting status of an order via email by a consumer. The consumer does the following:
1. Consumer emails Silk Engine; and
2. Silk Engine looks up email address and responds with order history and status:
   2a. If email address is not found Silk Engine will reply with an appropriate message to help Consumer find their order:
      1. Order had been placed using a different email address.

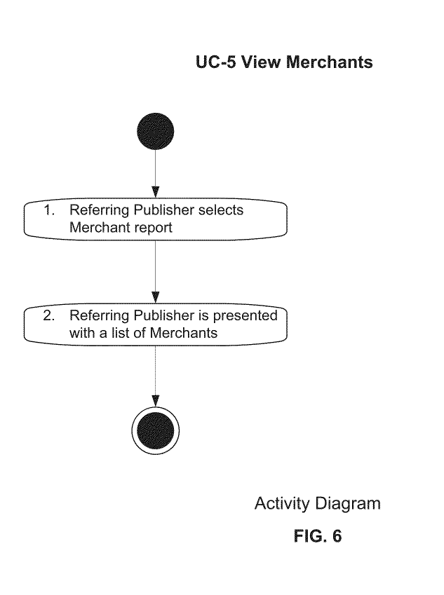

FIG. 6 illustrates a flow chart for process 116 for a referring publisher to view merchants. In which,
1. Referring Publisher selects Merchants report; and
2. Referring Publisher is presented with a list of Merchants.

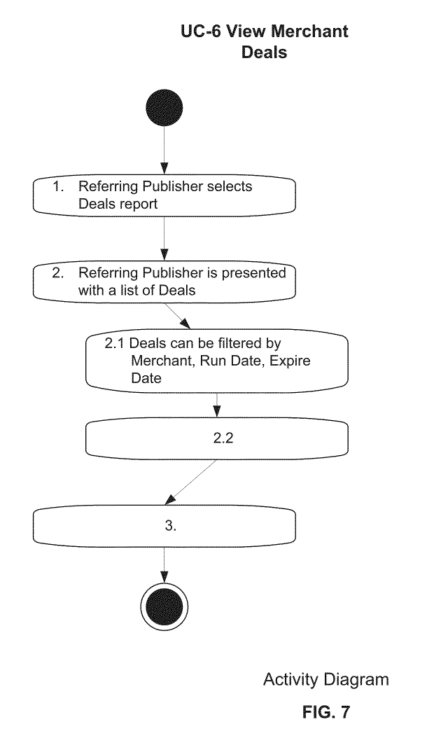

FIG. 7 illustrates a flow chart for a referring publisher to view merchant deals, part of Process 116. In which
1. Referring Publisher selects Deals report; and
2. Referring Publisher is presented with a list of deals:
   2.1. Deals can be filtered by my Merchant, Run Date, Expire Date.

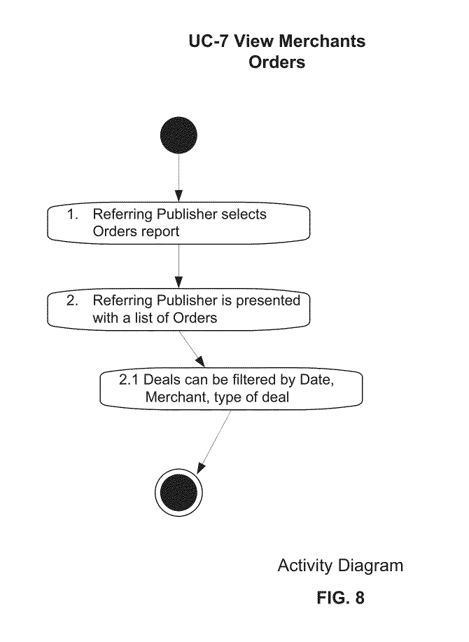

FIG. 8 illustrates a flow chart for viewing orders by a referring publisher.
1. A referring publisher selects for orders report;
2. Referring publisher is presented with a list of orders, the order list may be filtered by Date, Merchant, type of deals, etc.

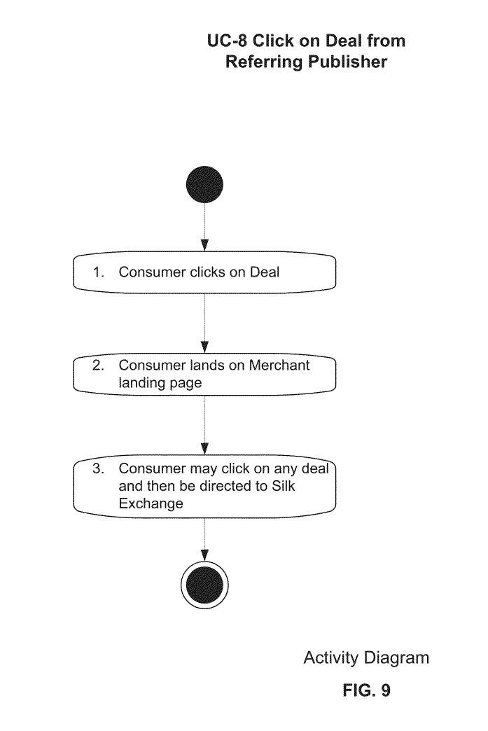

FIG. 9 illustrates a flow chart for process 118, clicking on deal from referring publisher site by a consumer, which includes the following:
1. Consumer clicks on Deal;
2. Consumer lands on Merchant landing page; and
3. Consumer may click on any deal and then be directed to Silk Engine to finish the transaction.

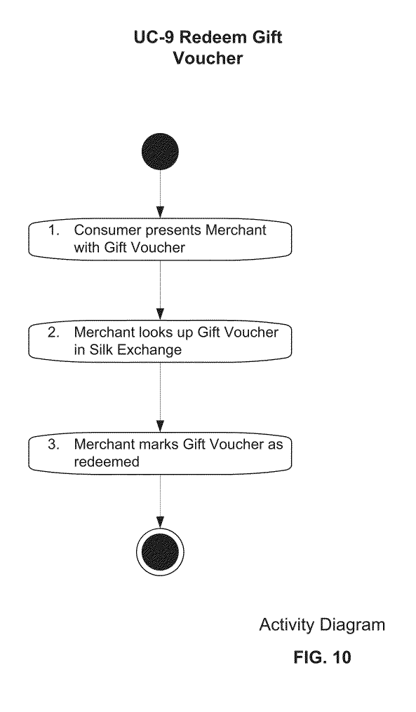

FIG. 10 is a flow chart for process 120 for a consumer to Redeem Gift Voucher, which includes the following:
1. Consumer presents Merchant with Gift Voucher;
2. Merchant looks up Gift Voucher in Silk Engine;
3. Merchant marks Gift Voucher as redeemed.

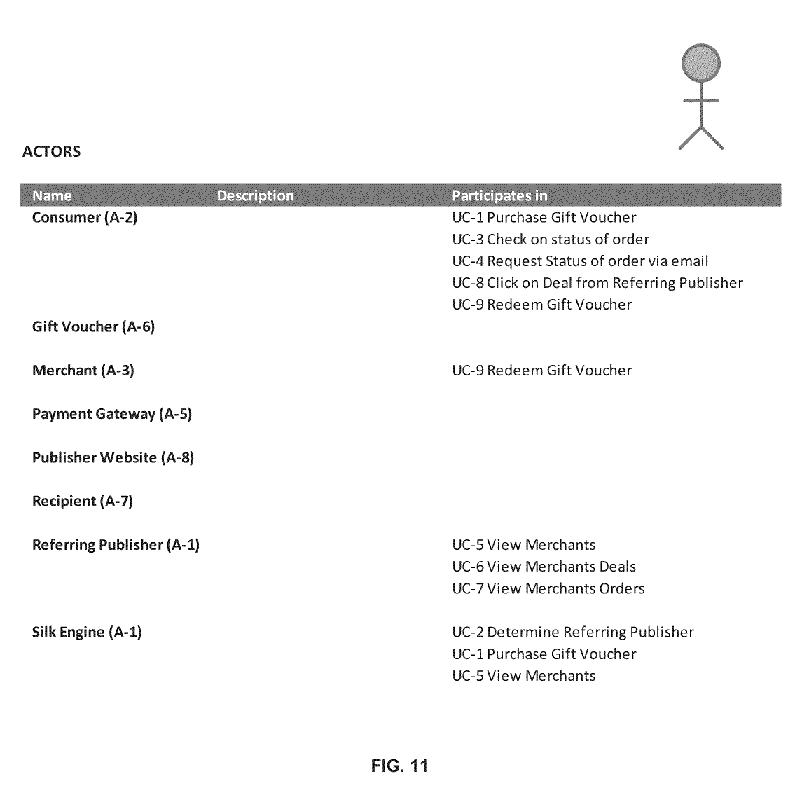

FIG. 11 illustrates the various example participants and their list of participating functions in terms of system design and functions. The system save and store several separate Actor properties and their associated data in their databases, the actors include: Consumer, Gift Voucher, Merchant, Payment Gateway, Publisher Website, Recipient, Referring Publisher and Silk Engine. Different Actors access different function processes. For example, Consumer accesses and participates functions of “Purchase Gift Voucher”, “Check on Status of Order”, Request Status of Order Via Email”, “Click on Deal From Referring Publisher”, “Redeem Gift Voucher”. Merchant accesses and participates functions of “Redeem Gift Voucher”. Referring Publisher accesses and participates functions of “View Merchants”, “View Merchant Deals”, “View Merchants Orders”. The Silk Engine has the access to functions of “Determine Referring Publisher”, “Purchase Gift Voucher” and “View Merchants”.

Apparatus, method and system 100 in ecommerce advantageously and uniquely create two distinct engines of consumer interaction. All purchasing consumers complete transactions on the selling merchant side of the wall in distinct “cocoons” within the selling merchant's own ecommerce platform. However, each referring publisher can see into the selling merchant's shopping environment through a walled off “cocoon” where all transactions are completed. This unique dual engine model has applications for selling merchants who are able to offer their products and services across many channels while at the same time maintaining control of the consumer shopping experience and administration of promotional activity for the selling merchant.

Referring Publishers are able to track efficacy of communication with customers of the publishers because the referring publishers have real time access to consumer behavior including purchase data. Selling merchants are able to launch campaigns directly to consumers of referring publishers rather than indirectly through traditional advertising means.

A referring publisher can broadcast an offer from the selling merchant either directly to the publisher's known customer base or through an advantaged advertising channel. Whether the prospective purchasing client's identity is known or unknown, the unique design of apparatus and method 100 enables the referring publisher to follow the trail of the consumer all the way into the shopping environment of the selling merchant, to monitor the details of the consumer's behavior in that environment and to capture the data on sales to that consumer. This detailed information is gained because the consumer is passed across the wall to a distinctly walled off shopping environment which can be replicated and modified by the selling merchant for an unlimited scale up of referring publishers. On completion of a sale, the referring publisher has all the same information about the consumer as the publisher would have had if the consumer had purchased the service or product from the publisher. However, the selling merchant has the advantage of selling its product or service directly to the consumer.

The apparatus and method 100 are uniquely and simultaneously a multi-channel ecommerce application, and also are interactive on both sides of the wall between the referring publisher and the selling merchant.

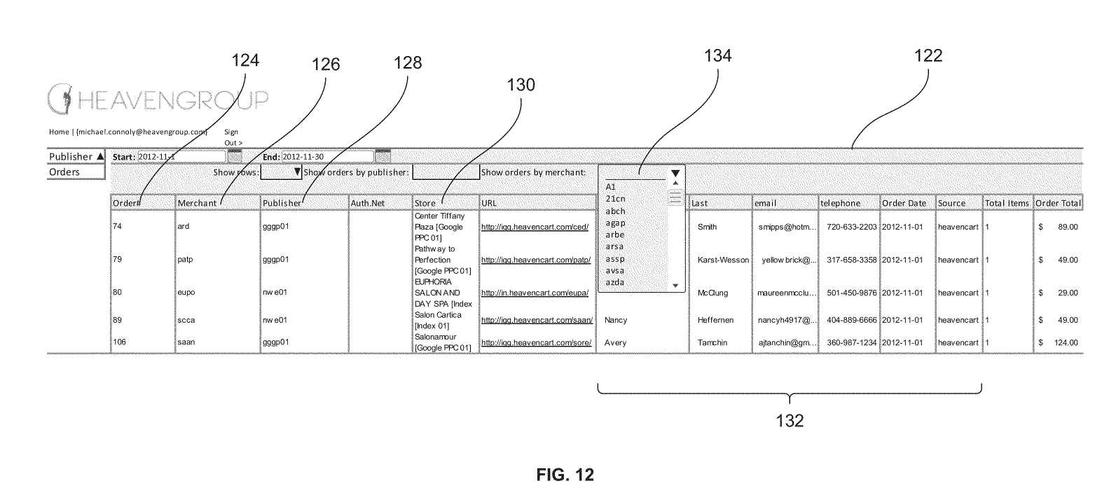

FIG. 12 through FIG. 14 show example computer screen display and design 122 for user interfaces and accessing of functions. A user log onto the multi-channel shopping network with dual interactivity as an administrator, as a publisher, and as a merchant, respectively.

In FIG. 12, data regarding orders, merchants, publishers, stores, and customers are displayed in columns 124, 126, 128, 130, and 132, respectively. The administrator has access to respective data for each of the general entities included in the network: the seller (merchant), the publisher, and the purchaser (consumer). pull-down menu 134 is used to show orders by merchant.

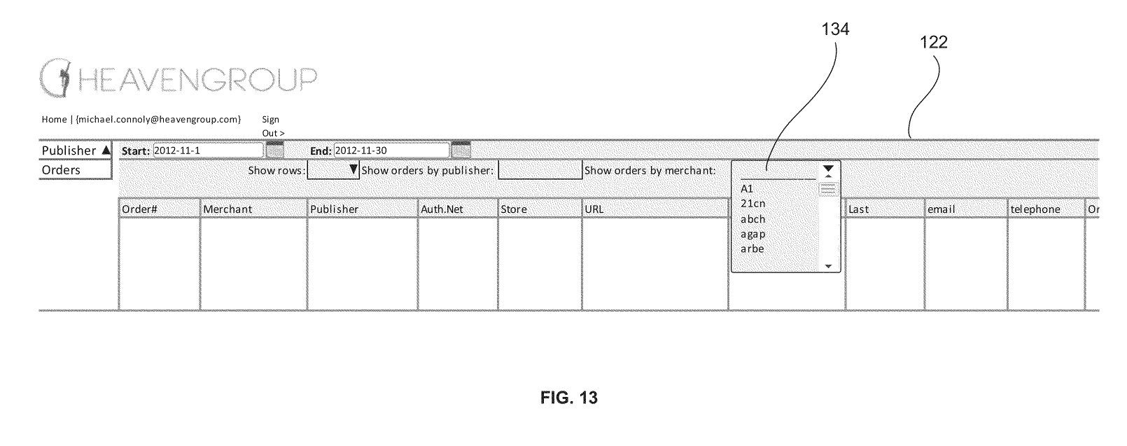

In FIG. 13, the publisher has selected menu 134; however, the publisher can only view data regarding merchants running respective campaigns with the publisher.

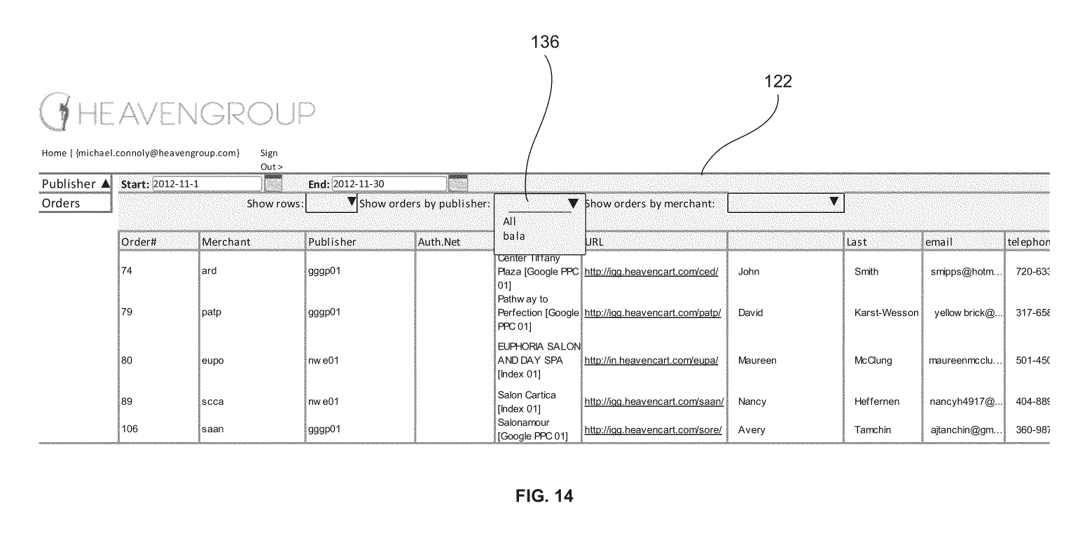

In FIG. 14, the merchant has selected pull-down menu 136, which enables the merchant to view data regarding all orders from the merchant and any publisher.

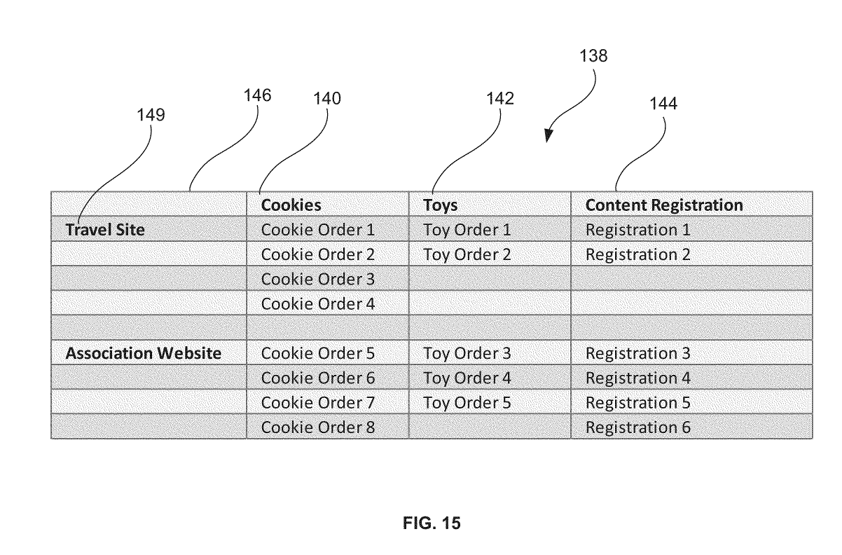

FIG. 15 shows a chart 138 illustrating an example use of a computer-based apparatus and method for multi-channel shopping with dual interactivity. Three merchants are using are logged into the system. Column 140 shows activities associated with a merchant selling cookies, column 142 shows activities associated with a merchant selling toys, and column 144 shows activities associated with a merchant taking contest registrations. Column 146 shows the related referring publishers, publisher 148 is a travel site and publisher 150 is an association website.

When referring publisher 148 logs into apparatus and method system 100, the publisher see all transactions that were initiated on their website across various merchants: Cookie Orders 1, 2, 3, and 4; Toy Orders 1 and 2; and Contest Registrations 1 and 2. When publisher 150 logs into the apparatus and method system 100 the publisher sees all transactions across its merchants: Cookie Orders 5, 6, 7, and 8; Toy Orders 3, 4, and 5; and Contest Registrations 3, 4, 5, and 6. When the cookie merchant user logs into the apparatus and method system 100, the merchant sees all transactions across all its referring publishers: Cooker Orders 1, 2, 3, 4, 5, 6, 7, and 8. When the toy merchant logs into the apparatus and method system 100, the merchant sees all transaction across all its referring publishers: Toy Orders 1, 2, 3, 4, and 5. When the contest registration merchant logs into the apparatus and method system 100, the merchant sees all transactions across all its referring publishers: Contest Registration 1, 2, 3, 4, and 5.

Thus, publishers have complete access to all data related to any purchases made from any merchants with whom the publishers have established a relationship via the apparatus and method system 100. However, data related to purchases made by other merchants, not in a relationship via apparatus and method 100 with the publisher may not be available to the publisher.

In like manner, merchants have complete access to all data related to any purchases made via any publishers with whom the merchants have established a relationship via the apparatus and method system 100. However, data related to purchases made via other publishers, not in a relationship via the apparatus and method system 100 with the merchant may not be available to the merchant.

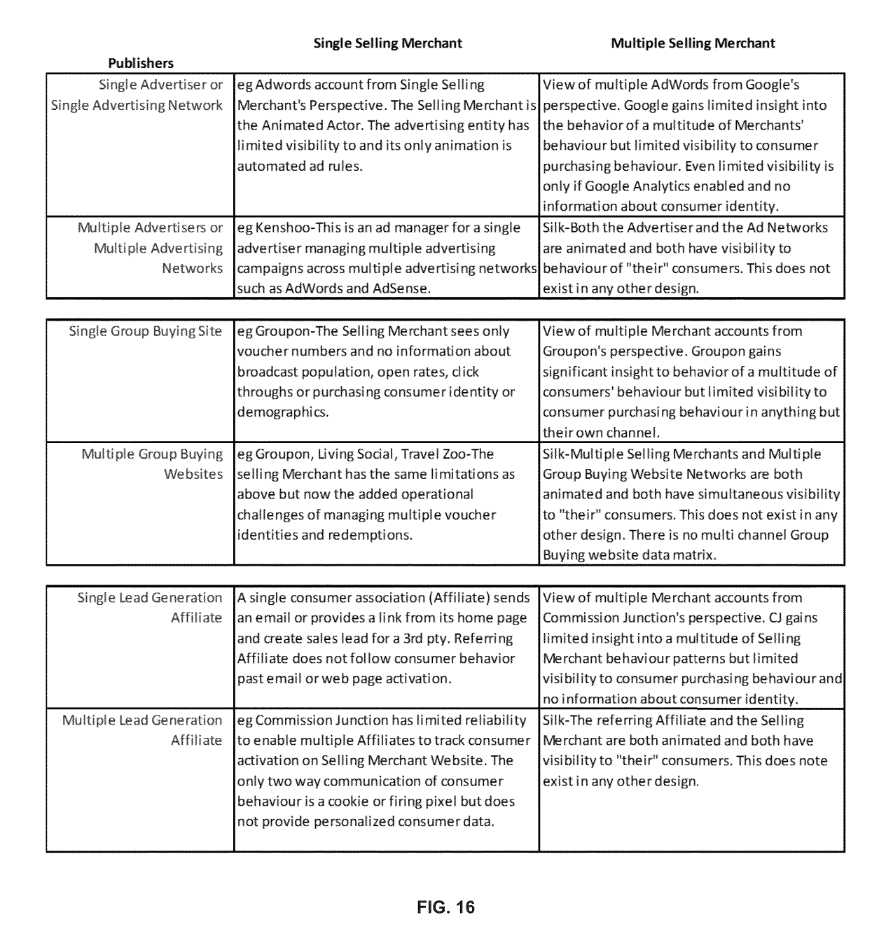

FIG. 16 is a chart illustrating various example relationships that can be established via various channels between publishers and selling merchants in the system. A single publisher may establish multiple relationships with a single merchant, or single relationship with multiple merchants, or multiple relationships with multiple merchants. The system can also establish multiple publishers in multiple relationships with multiple merchants.

In an example embodiment, apparatus system 100 includes at least one computer with at least one processor and at least one memory element. The at least one memory element is configured to store computer executable instructions and the at least one processor is configured to execute the computer executable instructions to perform the operations described above

The system also includes all the necessary databases and data structures to store all the content, sales deals, transactions histories and relationships, to track transaction progresses, etc. A person in the art understands the necessary databases can be built on need basis, and can change as ecommerce market changes. Core basic system Actors illustrated in FIG. 11 will remain.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A multichannel ecommerce computer network system, comprising:
a plurality of computer processors to perform a system of dual interactivity between a Referring Publisher and a Merchant,
wherein said system of dual interactivity includes
(a) a Merchant realm of confined functional processes specific to a relationship between said Merchant, a Consumer, and/or a Referring Publisher;
(b) a Referring Publisher realm of confined processes specific to a relationship between said Referring Publisher and said Consumer; and
(c) a dual interactive Engine comprising a set of functional processes that enable said Referring Publisher to view said merchant realm and enable said Merchant to view said Referring Publisher realm, and
an automatic process that automatically determines and said Referring Publisher's identity and establishes a relationship between said Referring Publisher and said Merchant through an IP address of said Referring Publisher.

2. The multichannel ecommerce computer network system of claim 1, wherein said automatic process automatically determines said Referring Publisher's identity and establishes a relationship between said Referring Publisher and said Merchant through a domain name of said Referring Publisher.

3. The multichannel ecommerce computer network system of claim 1, wherein said automatic process automatically determines said Referring Publisher's identity and establishes a relationship between said Referring Publisher and said Merchant through a query string.

4. The multichannel ecommerce computer network system of claim 1, wherein said automatic process automatically determines said Referring Publisher's identity and establishes a relationship between said Referring Publisher and said Merchant through an association of said Consumer.

5. The multichannel ecommerce computer network system of claim 1, wherein said Referring Publisher realm includes a process that enables the Referring Publisher assess a list of Merchant Deals from the dual interactive Engine.

6. The multichannel ecommerce computer network system of claim 1, wherein said Merchant realm includes Gift Voucher process that allows the Consumer to complete a purchase transaction related with a gift voucher related to the Referring Publisher.

7. The multichannel ecommerce computer network system of claim 1, wherein said Referring Publisher realm includes a View Merchant Process that enables the Referring Publisher to assess said dual Engine to retrieve Merchant data related with the Referring Publisher.

8. The multichannel ecommerce computer network system of claim 1, wherein said merchant realm includes a process that enables the Merchant to assess said dual Engine to retrieve the Referring Publisher data.

9. The multichannel ecommerce computer network system of claim 1, wherein said Referring Publisher realm includes a Click-on-Deal Process that enables the Consumer to access the confined functional processes of the Merchant realm.

10. The multichannel ecommerce computer network system of claim 1, wherein said merchant realm includes a Voucher process that enables the Merchant to manage a set of vouchers or promotion programs among a plurality of Referring Publishers.

11. A method for conducting managing multichannel ecommerce, comprising the steps of:
providing a plurality of computer processors to perform a system of dual interactivity between a Referring Publisher and a Merchant, wherein providing said system of dual interactivity comprises the steps of:
(a) providing a first computer module to function as a merchant realm of confined functional processes specific to a relationship between said Merchant, a Consumer, and/or a Referring Publisher;
(b) providing a second computer module to function as a Referring Publisher realm of confined processes specific to a relationship between said Referring Publisher and said Consumer; and
(c) providing a third computer module to function as a dual interactive Engine comprising a set of functional processes that enable said Referring Publisher to view said merchant realm and enable said Merchant to view said Referring Publisher realm, and
an automatic process that automatically determines said Referring Publisher's identity and establishes a relationship between said Referring Publisher and said Merchant through an IP address of said Referring Publisher.

12. The method for conducting managing multichannel ecommerce of claim 11, wherein said automatic process automatically determines said Referring Publisher's identity and establishes a relationship between said Referring Publisher and said Merchant through a domain name of said Referring Publisher.

13. The method for conducting managing multichannel ecommerce of claim 11, wherein said automatic process automatically determines said Referring Publisher's identity and establishes a relationship between said Referring Publisher and said Merchant through a query string.

14. The method for conducting managing multichannel ecommerce of claim 11, wherein said automatic process automatically determines said Referring Publisher's identity and establishes a relationship between said Referring Publisher and said Merchant through an association of said Consumer.

15. The method for conducting managing multichannel ecommerce of claim 11, wherein said Referring Publisher realm includes a Process that enables the Referring Publisher assess a list of Deals from the dual interactive Engine.

16. The method for conducting managing multichannel ecommerce of claim 11, wherein said Merchant realm includes Gift Voucher process that allows the Consumer to complete a purchase transaction related with a gift voucher related to the Referring Publisher.

17. The method for conducting managing multichannel ecommerce of claim 11, wherein said Referring Publisher realm includes a View Merchant Process that enables the Referring Publisher to assess said dual Engine to retrieve Merchant data related with the Referring Publisher.

18. The method for conducting managing multichannel ecommerce of claim 11, wherein said merchant realm includes a process that enables the Merchant to assess said dual Engine to retrieve the Referring Publisher data.

19. The method for conducting managing multichannel ecommerce of claim 11, wherein said Referring Publisher realm includes a Click-on-Deal Process that enables the Consumer to access the confined functional processes of the Merchant realm.

20. The method for conducting managing multichannel ecommerce of claim 11, wherein said merchant realm includes a Voucher process that enables the Merchant to manage a set of vouchers or promotion programs among a plurality of Referring Publishers.
